(19) United States
(12) Patent Application Publication
(10) Pub. No.: US 2025/0044589 A1
(43) Pub. Date: Feb. 6, 2025

(54) HEAD-UP DISPLAY SYSTEM

(71) Applicant: Yazaki Corporation, Tokyo (JP)

(72) Inventors: Masaya HATAKEYAMA, Shizuoka (JP); Kazuyoshi OGASAWARA, Shizuoka (JP)

(73) Assignee: Yazaki Corporation, Tokyo (JP)

(21) Appl. No.: 18/924,256

(22) Filed: Oct. 23, 2024

Related U.S. Application Data
(63) Continuation of application No. PCT/JP2023/037644, filed on Oct. 18, 2023.

(30) Foreign Application Priority Data
Oct. 24, 2022 (JP) 2022-169695

(51) Int. Cl. G02B 27/01; G01S 17/931; G02B 27/00

(52) U.S. Cl. CPC G02B 27/0101; G01S 17/931; G02B 27/0093; G02B 27/0179; G02B 2027/014; G02B 2027/0185

(57) ABSTRACT

An AR-HUD system includes a display unit, a line-of-sight detection unit, and a control unit. An object detection sensor detects a plurality of objects included in the landscape in front of a vehicle. The line-of-sight detection unit detects a line of sight of a driver of the vehicle. A distance output device identifies (measures) an actual distance from an eye point of the driver with respect to a specific object that is located ahead of the line of sight of the driver detected by the line-of-sight detection unit and matches the driver's focus among the plurality of objects detected by the object detection sensor. The control unit controls the display unit to superimpose and display a virtual image on the specific object, and executes double image prevention processing of adjusting a virtual image display distance from the eye point to the virtual image to the actual distance.

### CROSS-REFERENCE TO RELATED APPLICATION

This application is a continuation application of International Application No. PCT/JP2023/037644 filed on Oct. 18, 2023 which claims the benefit of priority from Japanese Patent Application No. 2022-169695 filed on Oct. 24, 2022 and designating the U.S., the entire contents of which are incorporated herein by reference.

### BACKGROUND OF THE INVENTION

### 1. Field of the Invention

The present invention relates to a head-up display system.

### 2. Description of the Related Art

Conventionally, as a head-up display system, for example, Japanese Patent Application Laid-open No. 2019-038451 describes a head-up display that emits display light indicating a display image to a transmission and reflection unit on a vehicle to allow a viewer to visually recognize a virtual image of the display image. This head-up display controls a display that displays a display image, and the display so that an emphasized image is superimposed and displayed on an object included in the landscape in front of the vehicle for at least a certain period of time until the vehicle is started and starts traveling. As a result, the head-up display demonstrates the superimposed display of the emphasized image before the vehicle starts traveling, thereby allowing the viewer to recognize the presence and significance of the function of superimposing and displaying the emphasized image on the object.

Meanwhile, in the head-up display described in Japanese Patent Application Laid-open No. 2019-038451 described above, for example, when an enhanced image is superimposed on an object and displayed, if the object is focused, the enhanced image may be visually recognized as a double image due to congestion.

### SUMMARY OF THE INVENTION

Therefore, the present invention has been made in view of the foregoing, and an object thereof is to provide a head-up display system capable of appropriately performing superimposed display.

In order to achieve the above mentioned object, a head-up display system according to one aspect of the present invention includes: a display unit that displays a virtual image by emitting display light including a display image toward a reflecting member, the reflecting member being provided in a vehicle and having transparency; an object detection unit that detects an object included in a landscape in front of the vehicle; a line-of-sight detection unit that detects a line of sight of a driver of the vehicle; a distance measuring unit that measures an actual distance from an eye point of the driver to a specific object among the objects detected by the object detection unit, the specific object being located ahead of the line of sight of the driver detected by the line-of-sight detection unit and matching the driver's focus; and a control unit that controls the display unit to superimpose and display the virtual image on the specific object, wherein the control unit controls the display unit to execute double image prevention processing of adjusting a virtual image display distance, which is a distance from the eye point of the driver to the virtual image, to the actual distance measured by the distance measuring unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a configuration example of an AR-HUD system according to an embodiment;

FIG. 2 is a block diagram illustrating a configuration example of the AR-HUD system according to the embodiment;

FIG. 3 is a schematic diagram illustrating a configuration example of a display according to the embodiment;

FIG. 4 is a schematic diagram illustrating a configuration example of the display according to the embodiment;

FIG. 5 is a diagram illustrating a relationship (1) between the parallax between a left-eye image and a right-eye image and a virtual image display position according to the embodiment;

FIG. 6 is a diagram illustrating a relationship (2) between the parallax between a left-eye image and a right-eye image and a virtual image display position according to the embodiment;

FIG. 7 is a diagram illustrating a relationship (3) between the parallax between a left-eye image and a right-eye image and a virtual image display position according to the embodiment; and

FIG. 8 is a flowchart illustrating an operation example of the AR-HUD system according to the embodiment.

### DETAILED DESCRIPTION OF THE PREFERRED EMBODIMENTS

A mode (embodiment) for carrying out the present invention will be described in detail with reference to the drawings. The present invention is not limited by the contents described in the following embodiment. In addition, the constituent elements described below include those that can be easily assumed by those skilled in the art and those that are substantially the same.

Furthermore, the configurations described below can be appropriately combined. In addition, various omissions, substitutions, or changes in the configuration can be made without departing from the gist of the present invention.

### Embodiment

An AR-HUD system 1 according to an embodiment will be described with reference to the drawings. The AR-HUD system 1 is an example of a head-up display system. The AR-HUD system 1 emits display light including a display image P toward a windshield W as a reflecting member provided in a vehicle and having transparency, and superimposes and displays a virtual image S reflected by the windshield W toward an eye point EP side on an object OJ. Here, the eye point EP is a position assumed in advance as the position of the driver's eyes or is the actual position of the driver's eyes. For example, in a case where the eye point EP is the actual position of the driver's eyes, the position of the driver's eyes is detected by a driver monitor 20 described later.

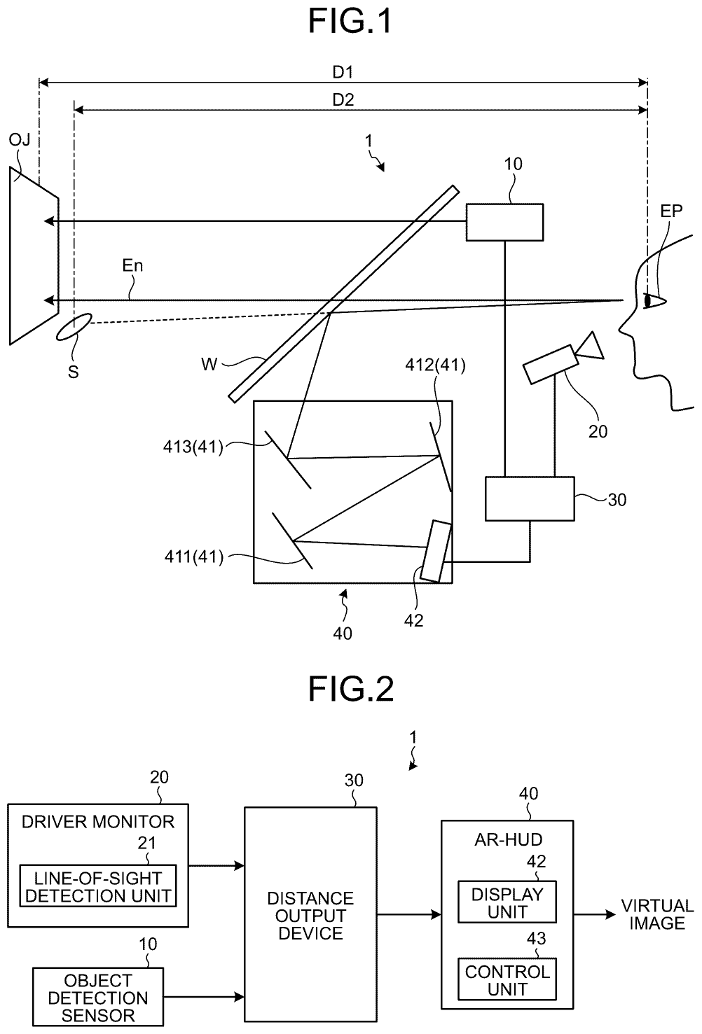

As illustrated in FIG. 1, the AR-HUD system 1 includes an object detection sensor 10, the driver monitor 20, a distance output device 30, and an AR-HUD device 40. The object detection sensor 10, the driver monitor 20, the distance output device 30, and the AR-HUD device 40 are communicably connected to each other.

The object detection sensor 10 is provided in the vehicle and detects the object OJ included in the landscape in front of the vehicle. Here, the object OJ is, for example, an object to be recognized by the driver, such as a person, another vehicle, or a sign. The object detection sensor 10 includes, for example, a stereo camera, and captures an image of the landscape in front of the vehicle. Then, the object detection sensor 10 performs image analysis on the captured image by a known image processing method such as a pattern matching method, and detects a plurality of objects OJ such as a person, another vehicle, and a sign. Furthermore, the object detection sensor 10 measures an actual distance D1 from the eye point EP of the driver with respect to the detected object OJ such as a person, another vehicle, or a sign. That is, the object detection sensor 10 measures the actual distance D1, which is the distance from the eye point EP of the driver to the object OJ. The object detection sensor 10 outputs, to the distance output device 30, object detection information indicating the position (XY coordinates) of the detected object OJ, the size of the object OJ, and the actual distance D1 from the eye point EP of the driver to the object OJ.

Next, the driver monitor 20 will be described. The driver monitor 20 is provided in the vehicle and monitors the driver, and includes a line-of-sight detection unit 21. The line-of-sight detection unit 21 detects a line of sight En of the driver. For example, the line-of-sight detection unit 21 is disposed in a state where a camera lens faces the driver. The line-of-sight detection unit 21 detects the line of sight En of the driver by a known line-of-sight detection method. For example, the line-of-sight detection unit 21 detects the line of sight En of the driver on the basis of the position of the pupil of the eyeball in a face image of the driver. In this case, the line-of-sight detection unit 21 compares a predetermined image of the eye with the face image of the driver, and detects the position of the pupil of the driver from the face image of the driver. The line-of-sight detection unit 21 detects the line of sight En of the driver from the detected position of the pupil of the driver. The line-of-sight detection unit 21 outputs line-of-sight information (XY coordinates) representing the detected line of sight En to the distance output device 30.

Next, the distance output device 30 will be described. The distance output device 30 outputs the actual distance D1 from the eye point EP to the object OJ. The distance output device 30 outputs the actual distance D1 from the eye point EP to the object OJ on the basis of the object detection information output from the object detection sensor 10 and the line-of-sight information of the driver output from the line-of-sight detection unit 21 of the driver monitor 20. The distance output device 30 detects a specific object OJ from among the plurality of objects OJ on the basis of, for example, line-of-sight information (XY coordinates) indicating the line of sight En of the driver. Specifically, the distance output device 30 detects, among the plurality of objects OJ, a specific object OJ that is located ahead of the line of sight En of the driver and matches the driver's focus. That is, the distance output device 30 detects the specific object OJ actually visually recognized by the driver among the plurality of objects OJ. In other words, the distance output device 30 detects the specific object OJ at a position (XY coordinates) that matches the position (XY coordinates) of the line of sight En of the driver. Then, the distance output device 30 outputs the position (XY coordinates) of the specific object OJ and object information indicating the actual distance D1 from the eye point EP to the specific object OJ to the AR-HUD device 40.

Next, the AR-HUD device 40 will be described. The AR-HUD device 40 emits display light including the display image P toward the windshield W, and superimposes and displays the virtual image S reflected by the windshield W toward the eye point EP on the object OJ. The AR-HUD device 40 includes a reflection unit 41, a display unit 42, and a control unit 43. The reflection unit 41, the display unit 42, and the control unit 43 are communicably connected to each other.

The reflection unit 41 reflects the display light emitted from the display unit 42 toward the windshield W. The reflection unit 41 includes a first intermediate mirror 411, a second intermediate mirror 412, and a last mirror 413. The first intermediate mirror 411 totally reflects the display light emitted from the display unit 42 toward the second intermediate mirror 412. The second intermediate mirror 412 totally reflects the display light emitted from the display unit 42 and reflected by the first intermediate mirror 411 toward the last mirror 413. The last mirror 413 totally reflects the display light emitted from the display unit 42 and reflected by the first intermediate mirror 411 and the second intermediate mirror 412 toward the windshield W.

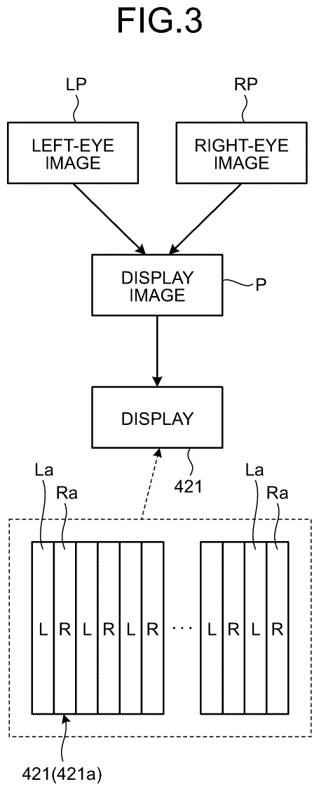

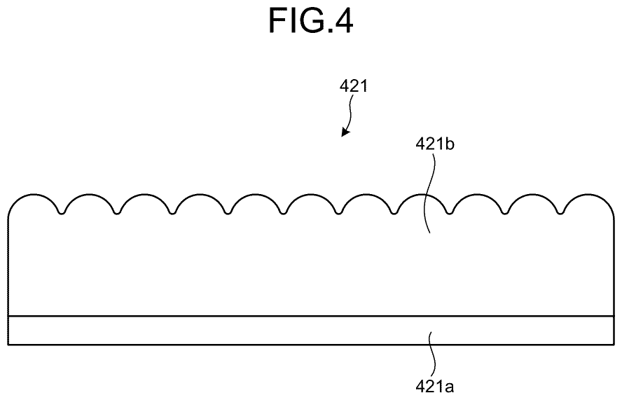

The display unit 42 emits display light including the display image P, and emits the display light to the windshield W via the reflection unit 41. The display unit 42 includes a display 421. For example, as illustrated in FIG. 4, the display 421 includes a liquid crystal panel 421a and a lenticular lens 421b. As illustrated in FIG. 3, the liquid crystal panel 421a includes a pixel row La for displaying a left-eye image LP and a pixel row Ra for displaying a right-eye image RP. The pixel row La and the pixel row Ra are alternately arranged pixel by pixel. The liquid crystal panel 421a is provided on the back surface of the lenticular lens 421b, and emits the display image P obtained by combining the left-eye image LP and the right-eye image RP to the lenticular lens 421b. Here, the display image P is a three-dimensional image including the left-eye image LP visually recognized by a left eye LE of the driver and the right-eye image RP visually recognized by a right eye RE of the driver. As illustrated in FIG. 4, the lenticular lens 421b is a lens in which an infinite number of fine elongated lumpy convex lenses are formed on the front surface. The lenticular lens 421b receives the display image P from the liquid crystal panel 421a, refracts and emits the display light of the left-eye image LP in the display image P toward the left eye LE of the driver, and refracts and emits the display light of the right-eye image RP toward the right eye RE of the driver. The display light including the left-eye image LP emitted from the lenticular lens 421b is incident on the left eye LE of the driver via the reflection unit 41 and the windshield W. The display light including the right-eye image RP emitted from the lenticular lens 421b is incident on the right eye RE of the driver via the reflection unit 41 and the windshield W. When the display light including the left-eye image LP is incident on the left eye LE and the display light including the right-eye image RP is incident on the right eye RE, the driver visually recognizes the three-dimensional virtual image S superimposed and displayed on the specific object OJ.

The control unit 43 controls the display unit 42 to superimpose and display the virtual image S on the specific object OJ. At this time, the control unit 43 executes double image prevention processing of adjusting a virtual image display distance D2 from the eye point EP to the virtual image S to the actual distance D1 from the eye point EP to the specific object OJ on the basis of the object information output from the distance output device 30. Typically, in a case where the double image prevention processing is executed, the control unit 43 matches the virtual image display distance D2 from the eye point EP to the virtual image S with the actual distance D1 from the eye point EP to the specific object OJ. Note that the control unit 43 does not need to match the virtual image display distance D2 from the eye point EP to the virtual image S with the actual distance D1 from the eye point EP to the specific object OJ as long as the double image due to congestion can be prevented, and the actual distance D1 and the virtual image display distance D2 may be slightly different. The above-described virtual image display distance D2 is a distance from the eye point EP to a display position at which the virtual image S is displayed. That is, the virtual image display distance D2 is a straight line distance connecting the eye point EP and a position at which the virtual image S is displayed. In other words, the virtual image display distance D2 is a distance from the eye point EP to an image forming position where the virtual image S is formed.

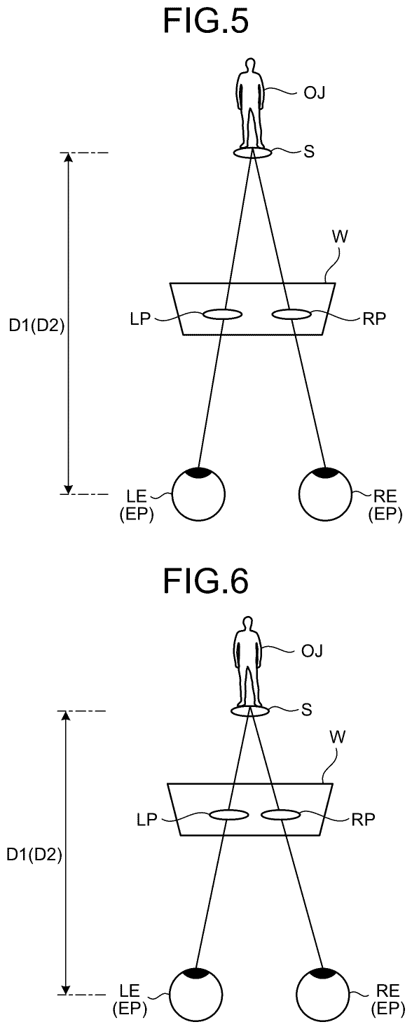

The control unit 43 controls the display unit 42 to change the parallax between the left-eye image LP and the right-eye image RP, thereby executing double image prevention processing of adjusting the virtual image display distance D2 to the actual distance D1. In the double image prevention processing, for example, the control unit 43 adjusts the inclination of the reflection surface of each mirror of the reflection unit 41 and changes the optical path of the display light including the left-eye image LP and the optical path of the display light including the right-eye image RP emitted from the lenticular lens 421b, thereby changing the parallax between the left-eye image LP and the right-eye image RP. For example, as illustrated in FIG. 5, the control unit 43 can relatively increase the virtual image display distance D2 by relatively increasing the parallax between the left-eye image LP and the right-eye image RP. In a case where the actual distance D1 from the eye point EP to the specific object OJ is relatively long, the control unit 43 relatively increases the parallax between the left-eye image LP and the right-eye image RP, adjusts the virtual image display distance D2 to the actual distance D1, and superimposes and displays the virtual image S on the specific object OJ.

In addition, as illustrated in FIG. 6, the control unit 43 can relatively reduce the virtual image display distance D2 by relatively reducing the parallax between the left-eye image LP and the right-eye image RP. In a case where the actual distance D1 from the eye point EP to the specific object OJ is relatively short, the control unit 43 relatively reduces the parallax between the left-eye image LP and the right-eye image RP, adjusts the virtual image display distance D2 to the actual distance D1, and superimposes and displays the virtual image S on the specific object OJ.

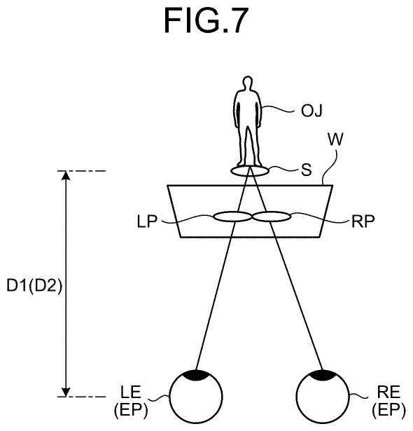

Furthermore, as illustrated in FIG. 7, the control unit 43 can relatively reduce the virtual image display distance D2 further by relatively reducing the parallax between the left-eye image LP and the right-eye image RP further. When the actual distance D1 from the eye point EP to the specific object OJ is relatively even shorter, the control unit 43 further reduces the parallax between the left-eye image LP and the right-eye image RP, adjusts the virtual image display distance D2 to the actual distance D1, and superimposes and displays the virtual image S on the specific object OJ.

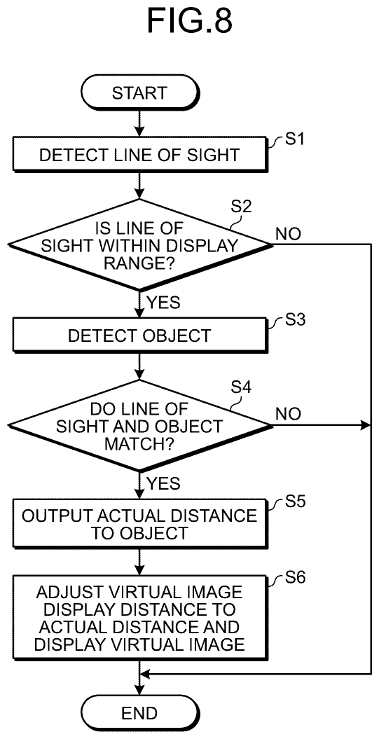

Next, an operation example of the AR-HUD system 1 will be described with reference to a flowchart of FIG. 8. The AR-HUD system 1 detects the line of sight En of the driver (Step S1). In the AR-HUD system 1, for example, the line-of-sight detection unit 21 detects the line of sight En of the driver on the basis of the position of the pupil of the eyeball of the face image of the driver.

Next, the AR-HUD system 1 determines whether or not the detected line of sight En of the driver is within a display range (Step S2). For example, the AR-HUD system 1 causes the driver monitor 20 to determine whether or not the line of sight En of the driver is included in a predetermined display range in which the virtual image S is displayed. If the line of sight En of the driver is within the display range (Step S2; Yes), the AR-HUD system 1 detects a plurality of objects OJ included in the landscape in front of the vehicle (Step S3). For example, the AR-HUD system 1 causes the object detection sensor 10 to perform image analysis on a captured image by a known image processing method such as a pattern matching method, and detects a plurality of objects OJ such as a person, another vehicle, and a sign. Then, the object detection sensor 10 measures the actual distance D1 from the eye point EP of the driver with respect to the detected object OJ such as a person, another vehicle, or a sign.

Next, the AR-HUD system 1 determines whether or not the line of sight En of the driver and the object OJ match (Step S4). For example, the AR-HUD system 1 causes the distance output device 30 to detect the specific object OJ from among the plurality of objects OJ on the basis of the line-of-sight information (XY coordinates) indicating the line of sight En of the driver. If the line of sight En of the driver and the object OJ match (Step S4; Yes), the AR-HUD system 1 outputs the actual distance D1 from the eye point EP of the driver to the matched specific object OJ (Step S5).

Next, the AR-HUD system 1 adjusts the virtual image display distance D2 from the eye point EP to the virtual image S to the actual distance D1 from the eye point EP to the specific object OJ, and superimposes and displays the virtual image S on the specific object OJ (Step S6). For example, the AR-HUD system 1 causes the control unit 43 to control the display unit 42 to change the parallax between the left-eye image LP and the right-eye image RP, thereby adjusting the virtual image display distance D2 to the actual distance D1 and superimposing and displaying the virtual image S on the specific object OJ.

Note that in Step S2 described above, if the detected line of sight En of the driver is not within the display range (Step S2; No), the AR-HUD system 1 ends the processing. In Step S4 described above, if the line of sight En of the driver and the object OJ do not match (Step S4; No), the AR-HUD system 1 ends the processing.

As described above, the AR-HUD system 1 according to the embodiment includes the display unit 42, the line-of-sight detection unit 21, and the control unit 43. The display unit 42 displays the virtual image S by emitting display light including the display image P toward the windshield W provided in the vehicle and having transparency. The object detection sensor 10 detects a plurality of objects OJ included in the landscape in front of the vehicle. The line-of-sight detection unit 21 detects line of sight En of the driver of the vehicle. The distance output device 30 identifies (measures) the actual distance D1 from the eye point EP of the driver with respect to a specific object OJ that is located ahead of the line of sight En of the driver detected by the line-of-sight detection unit 21 and matches the driver's focus among the plurality of objects OJ detected by the object detection sensor 10. The control unit 43 controls the display unit 42 to superimpose and display the virtual image S on the specific object OJ, and executes double image prevention processing of adjusting the virtual image display distance D2 from the eye point EP of the driver to the virtual image S to the actual distance D1.

With this configuration, the AR-HUD system 1 can prevent the virtual image S from appearing as a double image due to congestion when the driver focuses on the specific object OJ. In particular, when displaying the virtual image S indicating emergency information, the AR-HUD system 1 can cause the driver to clearly view the virtual image S. Thus, the AR-HUD system 1 can superimpose and display the virtual image S appropriately.

In the AR-HUD system 1, the display image P is a three-dimensional image including the left-eye image LP visually recognized by the left eye LE of the driver and the right-eye image RP visually recognized by the right eye RE of the driver. The control unit 43 controls the display unit 42 to change the parallax between the left-eye image LP and the right-eye image RP, thereby executing double image prevention processing of adjusting the virtual image display distance D2 to the actual distance D1. With this configuration, the AR-HUD system 1 can prevent the three-dimensional virtual image S from appearing as a double image due to congestion when the driver focuses on the specific object OJ. As a result, the AR-HUD system 1 can superimpose and display the three-dimensional virtual image S appropriately.

### Modification

Next, a modification of the embodiment will be described. Note that in the modification, constituent elements equivalent to those in the embodiment are denoted by the same reference numerals, and a detailed description thereof will be omitted. In the AR-HUD system 1, the example in which the display image P is a three-dimensional image has been described, but the display image P is not limited thereto, and may be, for example, a two-dimensional image visually recognized by the left eye LE and the right eye RE of the driver. In this case, a control unit 43 controls a display unit 42 to change an optical path length of display light, thereby executing double image prevention processing of adjusting a virtual image display distance D2 to an actual distance D1. For example, the display unit 42 includes an optical path length adjusting unit including a plurality of folded mirrors. The optical path length adjusting unit adjusts (selects) the folding mirror that reflects the display light on the basis of the actual distance D1 to change the optical path length of the display light to a windshield W, and adjusts the virtual image display distance D2 for displaying a virtual image S including a two-dimensional image to the actual distance D1. As a result, the AR-HUD system 1 according to the modification can prevent the two-dimensional virtual image S from appearing as a double image due to congestion when the driver focuses on a specific object OJ. As a result, the AR-HUD system 1 according to the modification can superimpose and display the two-dimensional virtual image S appropriately.

The example in which the object detection sensor 10 includes the stereo camera has been described, but the present invention is not limited thereto, and any sensor may be used as long as the sensor can detect the object OJ and measure the actual distance D1. The object detection sensor 10 may include, for example, a known sensor such as a monocular camera, an infrared camera, a laser radar, a millimeter wave radar, or an ultrasonic sensor.

The head-up display system according to the present embodiment can prevent a virtual image from appearing as a double image due to congestion when a driver focuses on a specific object. As a result, the head-up display system can appropriately perform superimposed display.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A head-up display system comprising:
a display unit that displays a virtual image by emitting display light including a display image toward a reflecting member, the reflecting member being provided in a vehicle and having transparency;
an object detection unit that detects an object included in a landscape in front of the vehicle;
a line-of-sight detection unit that detects a line of sight of a driver of the vehicle;
a distance measuring unit that measures an actual distance from an eye point of the driver to a specific object among the objects detected by the object detection unit, the specific object being located ahead of the line of sight of the driver detected by the line-of-sight detection unit and matching the driver's focus; and
a control unit that controls the display unit to superimpose and display the virtual image on the specific object, wherein
the control unit controls the display unit to execute double image prevention processing to prevent a double image due to congestion by adjusting a virtual image display distance, which is a distance from the eye point of the driver to the virtual image, to the actual distance measured by the distance measuring unit.

2. The head-up display system according to claim 1, wherein
the display image is a three-dimensional image including a left-eye image visually recognized by the left eye of the driver and a right-eye image visually recognized by the right eye of the driver, and
the control unit controls the display unit to change the parallax between the left-eye image and the right-eye image to execute the double image prevention processing of adjusting the virtual image display distance to the actual distance.

3. The head-up display system according to claim 1, wherein
the display image is a two-dimensional image visually recognized by the left eye and the right eye of the driver, and
the control unit controls the display unit to change an optical path length of the display light to execute the double image prevention processing of adjusting the virtual image display distance to the actual distance.
